(19) United States
(12) Patent Application Publication
(10) Pub. No.: US 2017/0006224 A1
(43) Pub. Date: Jan. 5, 2017

(54) CAMERA OPERATING METHOD AND ELECTRONIC DEVICE IMPLEMENTING THE SAME

(71) Applicant: Samsung Electronics Co .. Ltd., Gyeonggi-do (KR)

(72) Inventors: Dongsoo KIM, Gyeonggi-do (KR); Hwayong KANG, Gyeonggi-do (KR); Youngkwon YOON, Seoul (KR); Donghoon JANG, Gyeonggi-do (KR)

(73) Assignee: Samsung Electronics Co., Ltd.

(21) Appl. No.: 15/191,658

(22) Filed: Jun. 24, 2016

(30) Foreign Application Priority Data
Jul. 3, 2015 (KR) 10-2015-0095538

(51) Int. Cl. H04N 5/232

(52) U.S. Cl. CPC H04N 5/23241; H04N 5/23216; H04N 5/23245; H04N 5/23293

(57) ABSTRACT

An image sensor is provided which includes a pixel array, a memory for storing setting information received from an external device of the image sensor, and a controller. The controller is configured to generate an image using a signal sensed by the pixel array based on the setting information stored in the memory.

### PRIORITY

This application claims priority under 35 U.S.C. §119(a) to Korean Patent Application Serial No. 10-2015-0095538, which was filed in the Korean Intellectual Property Office on Jul. 3, 2015, the entire content of which is incorporated herein by reference.

### BACKGROUND

1. Field of the Disclosure

The present disclosure relates to a method of operating a camera and an electronic device implementing the same.

2. Description of the Related Art

An electronic device provides a user with various functions or programs. A portable electronic device (such as a smart phone, a tablet computer, and the like) provides a user with convenience through a camera function. The camera function is generally executed by receiving an input from a user, and a user may execute the camera function using a user interface provided with a camera. When the camera function is executed, the electronic device displays a preview image on a screen, and photographs a subject based on a command from a user. An electronic device may transmit, to an image sensor, various set values for photographing when a camera function is executed. A booting time for operating a camera may occupy a large portion of a camera startup time. Also, time expended for loading the setting of the image sensor may occupy a large portion of the camera startup time. The booting time or the loading time may take hundreds of milliseconds and, thus, a large amount of time may be expended until the camera is ready to begin photographing.

### SUMMARY

Various aspects of the present disclosure provide a method and apparatus for promptly displaying a preview image in response to a camera execution request by a user. Also, various aspects of the present disclosure provide a camera module including a memory that is capable of maintaining a set value of an image sensor based on a designated condition, and a control method thereof. Also, according to various aspects of the present disclosure, an electronic device is provided that may promptly provide a preview image by request of a user by storing, in advance, a setting of an image sensor in a memory of the image sensor and generating image data based on the setting stored in the memory.

According to various aspects of the present disclosure, there is provided an image sensor, including a pixel array, a memory configured to store setting information received from an external device of the image sensor, and a controller, wherein the controller is configured to generate an image using a signal sensed in the pixel array based on the setting information stored in the memory.

According to various aspects of the present disclosure, there is provided an electronic device, including a first memory, an image sensor configured to include a second memory, a processor, and an interface that intermediates communication between the image sensor and the processor, wherein the processor is configured to transmit setting information stored in the first memory to the second memory through the interface, and to generate an image based on setting information stored in the second memory.

According to various aspects of the present disclosure, there is provided a method of operating an electronic device including an image sensor and a power management module, the method including controlling the power management module to supply power to the memory of the image sensor when a power source of the electronic device is turned on or when a screen of the electronic device is turned on, transmitting a setting to the memory, in response to a first user input, commanding the power management module to supply power to an analog block and a digital control block of the image sensor, which is configured to execute a streaming operation including generating and outputting the image data based on a setting stored in the memory, and commanding the image sensor to begin the streaming operation, and, in response to a second user input, commanding the image sensor to suspend the streaming operation, and commanding the power management module to suspend supplying power to the analog block and the digital control block.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a block diagram of an electronic device in a network setting according to various embodiments of the present disclosure;

FIG. 2 is a block diagram of an image sensor according to various embodiments of the present disclosure;

FIG. 3 illustrates a camera module according to various embodiments of the present disclosure;

FIG. 4A is a state machine illustrating a change in the state of an image sensor according to various embodiments of the present disclosure;

FIG. 4B illustrates a change in the state of an image sensor according to various embodiments of the present disclosure;

FIG. 5 is a flowchart illustrating a method for a processor to operate a camera according to various embodiments of the present disclosure;

FIG. 6 is a flowchart illustrating a method for a processor to change streaming according to various embodiments of the present disclosure;

FIG. 7 is a flowchart illustrating an operation method of an image sensor according to various embodiments of the present disclosure;

FIG. 8 is a flowchart illustrating another operation method of an image sensor according to various embodiments of the present disclosure;

FIG. 9 is a block diagram of a portable electronic device according to various embodiments of the present disclosure; and

FIG. 10 is a block diagram of a program module according to various embodiments of the present disclosure.

### DETAILED DESCRIPTION

The present disclosure will be described with reference to the accompanying drawings. Although specific embodiments are illustrated in the drawings and related detailed descriptions are discussed in the present specification, the present disclosure may have various modifications and several embodiments. However, various embodiments of the present disclosure are not limited to a specific implementation form and it should be understood that the present disclosure includes all changes and/or equivalents and substitutes included in the spirit and scope of various embodiments of the present disclosure. In descriptions of the drawings, similar components may be designated by similar reference numerals.

The terms “include” or “may include” which may be used in describing various embodiments of the present disclosure refer to the existence of a corresponding disclosed function, operation or component which may be used in various embodiments of the present disclosure and do not limit one or more additional functions, operations, or components. In various embodiments of the present disclosure, terms such as “include” or “have” may be construed to denote a certain characteristic, number, step, operation, constituent element, component or a combination thereof, but are not be construed to exclude the existence of, or a possibility of, the addition of one or more other characteristics, numbers, steps, operations, constituent elements, components or combinations thereof.

In various embodiments of the present disclosure, the expressions “or” or “at least one of A or/and B” include any or all of combinations of words listed together. For example, the expressions “A or B” or “at least A or/and B” may include A, may include B, or may include both A and B.

The expressions “1”, “2”, “first”, or “second” used in various embodiments of the present disclosure may modify various components of the various embodiments but do not limit the corresponding components. For example, the above expressions do not limit the sequence and/or importance of the components. The expressions may be used for distinguishing one component from other components. For example, a first user device and a second user device may indicate different user devices although both of them are user devices. For example, without departing from the scope of the present disclosure, a first structural element may be referred to as a second structural element. Similarly, the second structural element also may be referred to as the first structural element.

When it is stated that a component is “coupled to” or “connected to” another component, the component may be directly coupled or connected to another component or another component may exist between the component and another component. In contrast, when it is stated that a component is “directly coupled to” or “directly connected to” another component, another component does not exist between the component and another component.

The terms used in describing various embodiments of the present disclosure are only examples for describing a specific embodiment but do not limit the various embodiments of the present disclosure. Singular forms are intended to include plural forms unless the context clearly indicates otherwise.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the same meanings as the contextual meanings in the relevant field of art, and are not to be interpreted to have ideal or excessively formal meanings unless clearly defined in the present disclosure.

An electronic device according to various embodiments of the present disclosure may be a device including a communication function. For example, the electronic device may be one or a combination of a smart phone, a tablet personal computer (PC), a mobile phone, a video phone, an e-book reader, a desktop PC, a laptop PC, a netbook computer, a personal digital assistant (PDA), a camera, and a wearable device (e.g., a head-mounted-device (HMD) such as electronic eyeglasses, electronic clothes, an electronic bracelet, an electronic necklace, an electronic accessary, an electronic tattoo, and a smart watch).

According to some embodiments, the electronic device may be a smart home appliance having a communication function. The smart home appliance may include at least one of a television (TV), a digital video disk (DVD) player, an audio player, an air conditioner, a cleaner, an oven, a microwave oven, a washing machine, an air cleaner, a set-top box, a TV box (e.g., Samsung HomeSync™, Apple TV™, or Google TV™), game consoles, an electronic dictionary, an electronic key, a camcorder, and an electronic frame.

According to some embodiments, the electronic device may include at least one of various types of medical devices (e.g., magnetic resonance angiography (MRA), magnetic resonance imaging (MRI), computed tomography (CT), a scanner, an ultrasonic device and the like), a navigation device, a global navigation satellite system (GNSS) receiver, an event data recorder (EDR), a flight data recorder (FDR), a vehicle infotainment device, electronic equipment for a ship (e.g., a navigation device for ship, a gyro compass and the like), avionics, a security device, a head unit for a vehicle, an industrial or home robot, an automatic teller machine (ATM), a point of sale (POS) terminal, and an Internet of Things (IoT) device (e.g., a fire alarm, various sensors, electric or gas meter units, a sprinkler, a thermostat, a streetlamp, a toaster, sport outfits, a hot-water tank, a heater, a boiler and the like).

According to some embodiments, the electronic device may include at least one of furniture or a part of a building/structure, an electronic board, an electronic signature receiving device, a projector, and various types of measuring devices (e.g., a water meter, an electricity meter, a gas meter, a radio wave meter and the like) including a camera function. The electronic device may be one or a combination of the above described various devices. Further, the electronic device may be a flexible device. It is apparent to those skilled in the art that the electronic device is not limited to the above described devices.

Hereinafter, an electronic device according to various embodiments of the present disclosure will be described with reference to the accompanying drawings. The term “user” used in various embodiments may refer to a person who uses an electronic device or a device (e.g., an artificial intelligence electronic device) which uses an electronic device.

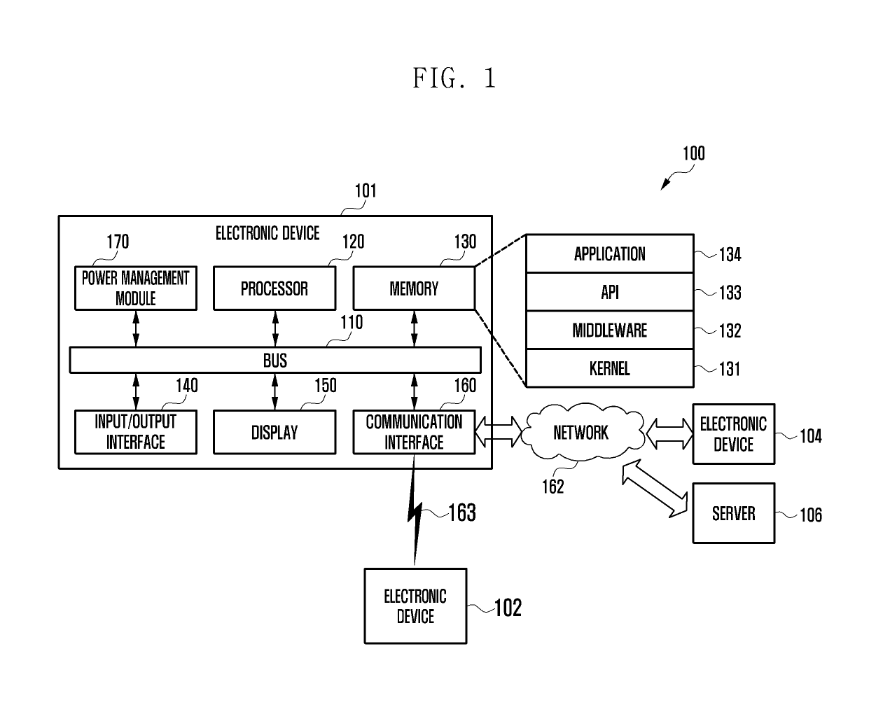

FIG. 1 illustrates a network environment 100 including an electronic device 101 according to various embodiments of the present disclosure. Referring to FIG. 1, the electronic device 101 includes various components including a bus 110, a processor 120, a memory 130, an input/output interface 140, a display 150, a communication interface 160, and a power management module 170.

The bus 110 may be a circuit connecting the above described components and transmitting communication (e.g., a control message) between the above described components.

The processor 120 may receive commands from other components (e.g., the memory 130, the input/output interface 140, the display 150, the communication interface 160, or the power management module 170) through the bus 110, analyze the received commands, and execute calculation or data processing according to the analyzed commands.

The memory 130 stores commands or data received from the processor 120 or other components (e.g., the input/output interface 140, the display 150, the communication interface 160, or the power management module 170) or generated by the processor 120 or other components. The memory 130 may store commands or data related to the other components. For example, the memory 130 may store settings of a camera such as AE (auto exposure), AWB (auto white balance), AF (auto focus), ISO (international organization for standardization) sensitivity, shutter speed, aperture value, zoom magnification and the like. The memory 130 may store software and/or a program. For example, the program includes a kernel 131, middleware 132, an application programming interface (API) 133, and an application program (or an application) 134. At least part of the kernel 131, the middleware 132 or the API 133 may be referred to as an operating system (OS).

The kernel 131 controls or manages system resources (e.g., the bus 110, the processor 120, or the memory 130) used for executing an operation or function implemented by the remaining other programming modules, for example, the middleware 132, the API 133, or the application 134. Further, the kernel 131 provides an interface for accessing individual components of the electronic device 101 from the middleware 132, the API 133, or the application 134 to control or manage the components.

The middleware 132 performs a relay function of allowing the API 133 or the application 134 to communicate with the kernel 131 to exchange data. Further, in operation requests received from the application 134, the middleware 132 performs a control for the operation requests (e.g., scheduling or load balancing) by using a method of assigning a priority, by which system resources (e.g., the bus 110, the processor 120, the memory 130 and the like) of the electronic device 101 may be used, to the application 134.

The API 133 is an interface by which the application 134 may control a function provided by the kernel 131 or the middleware 132 and includes, for example, at least one interface or function (e.g., command) for a file control, a window control, image processing, or a character control.

According to various embodiments, the application 134 may include a short message service (SMS)/multimedia messaging service (MMS) application, an email application, a calendar application, an alarm application, a health care application (e.g., application measuring quantity of exercise or blood sugar level) or an environment information application (e.g., application providing information on barometric pressure, humidity or temperature). Additionally, or alternatively, the application 134 may be an application related to an information exchange between the electronic device 101 and an external electronic device (e.g., electronic device 104). The application 134 related to the information exchange may include, for example, a notification relay application for transferring particular information to the external electronic device or a device management application for managing the external electronic device.

For example, the notification relay application may include a function of transmitting notification information generated by another application (e.g., an SMS/MMS application, an email application, a health care application or an environment information application) of the electronic device 101 to the external electronic device (e.g., electronic device 104). Additionally, or alternatively, the notification relay application may receive notification information from, for example, the external electronic device 104, and provide the received notification information to the user. The device management application may manage (e.g., install, remove, or update) at least a part of functions of the electronic device. For example, the device management application may turn on/off the external electronic device (or some components of the external electronic device), control a brightness of the display of the external electronic device or communicate with the electronic device 101, an application executed in the external electronic device 104, or a service (e.g., call service or message service) provided by the external electronic device 104.

According to various embodiments, the application 134 may include an application designated according to an attribute (e.g., type of electronic device) of the external electronic device 104. For example, when the external electronic device 104 is an MP3 player, the application 134 may include an application related to music reproduction. Similarly, when the external electronic device 104 is a mobile medical device, the application 134 may include an application related to health care. The application 134 may include at least one of an application designated to the electronic device 101 and an application received from an external electronic device (e.g., server 106 or electronic device 104).

The input/output interface 140 transmits a command or data input from the user through an input/output device 140 (e.g., a sensor, a keyboard, or a touch screen) to the processor 120, the memory 130, the communication interface 160, or the display control module 150 through, for example, the bus 110. For example, the input/output interface 140 may provide data on a user's touch input through a touch screen to the processor 120. Further, the input/output interface 140 may output a command or data received through, for example, the bus 110, from the processor 120, the memory 130, the communication interface 160, or the power management module 170 through the input/output device (e.g., a speaker or a display). For example, the input/output interface 140 may output voice data processed through the processor 120 to the user through the speaker.

The display 150 may include, for example, a liquid crystal display (LCD), a flexible display, a transparent display, a light-emitting diode (LED) display, an organic light-emitting diode (OLED) display, a microelectromechanical systems (MEMS) display, or an electronic paper display. The display 150 may visually display, for example, various content (e.g., text, image, video, icon, symbol, etc.) to users. The display 150 may include a touch screen and receive, for example, a touch, gesture, proximity, or hovering input using an electronic pen or a user's body. According to an embodiment, the display 150 may be one or more displays. For example, the display 150 may be included in the electronic device 101 or included in an external device (e.g., the electronic device 102 or 104) having a wired or wireless connection with the electronic device 101, thus outputting information offered by the electronic device 101 to users.

According to an embodiment, the display 150 may be attachable to or detachable from the electronic device 101. For example, the display 150 may include an interface which may be mechanically or physically connected with the electronic device 101. In case the display 150 is detached (e.g., separated) from the electronic device 101 by a user's selection, the display 150 may receive various control signals or image data from the power management module 170 or the processor 120, e.g., through wireless communication.

The communication interface 160 may establish communication between the electronic device 101 and any external device (e.g., the first external electronic device 102, the second external electronic device 104, or the server 106). For example, the communication interface 160 may be connected with a network 162 through wired or wireless communication and thereby communicate with any external device (e.g., the first external electronic device 102, the second external electronic device 104, or the server 106).

According to an embodiment, the electronic device 101 may be connected with the first external electronic device 102 and the second external electronic device 104 without using the communication interface 160. For example, based on at least one of a magnetic sensor, a contact sensor, a light sensor, and the like that is equipped in the electronic device 101, the electronic device 101 may sense whether at least one of the first and second external electronic devices 102 and 104 is contacted with at least part of the electronic device 101, or whether at least one of the first and second external electronic device 102 and 104, respectively, is attached to at least part of the electronic device 101.

Wireless communication may use, as a cellular communication protocol, at least one of LTE (long-term evolution), LTE-A (LTE advance), CDMA (code division multiple access), WCDMA (wideband CDMA), UMTS (universal mobile telecommunications system), WiBro (Wireless Broadband), GSM (global system for mobile communications), and the like, for example. A short-range communication 163 may include, for example, at least one of Wi-Fi, Bluetooth, near field communication (NFC), magnetic secure transmission or near field magnetic data stripe transmission (MST), and global navigation satellite system (GNSS), and the like. The GNSS may include at least one of, for example, a global positioning system (GPS), a global navigation satellite system (Glonass), a Beidou navigation satellite system (Beidou), and Galileo (European global satellite-based navigation system). Hereinafter, the term “GPS” may be interchangeably used with the term “GNSS” in the present disclosure. Wired communication may include, for example, at least one of USB (universal serial bus), HDMI (high definition multimedia interface), RS-232 (recommended standard-232), POTS (plain old telephone service), and the like. The network 162 may include telecommunication network, for example, at least one of a computer network (e.g., LAN or WAN), internet, and a telephone network.

The first and second external electronic devices 102 and 104 may be identical to, or different from, the electronic device 101. According to an embodiment, the first and second external electronic devices 102 and 104 may include, for example, a plurality of electronic devices. The server 106 may include a single server or a group of servers. All or part of operations executed in the electronic device 101 may be executed in other electronic device(s), such as the first and second electronic devices 102 and 104 or the server 106.

According to an embodiment, in case the electronic device 101 is required to perform a certain function or service automatically or by request, the electronic device 101 may request another device (e.g., the electronic device 102 or 104 or the server 106) to execute instead, or additionally at least part, of at least one or more functions associated with the required function or service. The requested device may execute the requested function and deliver the result of execution to the electronic device 101. Then, the electronic device 101 may offer the required function or service, based on the received result or by processing the received result. For the above, cloud computing technology, distributed computing technology, or client-server computing technology may be used, for example.

The power management module 170 may control the power of the electronic device 101. The electronic device 101 may be an electronic device that is provided with power through a battery, but is not limited thereto. According to an embodiment of the present disclosure, the power management module 170 may include a power management integrated circuit (PMIC), a charger integrated circuit (IC), or a battery gauge. For example, when the power of the electronic device 101 is turned on, the power management module 170 (e.g., PMIC) may supply the power of a battery to other components (e.g., the processor 120, the memory 130, an image sensor, and the like).

According to an embodiment of the present disclosure, the power management module 170 may supply power to some (e.g., an embedded memory of a camera and an input/output interface for communication between the processor 120 and an embedded memory) of the components of an image sensor. Also, the power management module 170 may receive an instruction from the processor 120 through the bus 110, and may control supplying power in response to the instruction. For example, the power management module 170 may supply power to some other components (e.g., an analog block and a digital control block of the image sensor) of the image sensor in response to an instruction received from the processor 120.

The PMIC may use, for example, a wired and/or wireless charging method. The wireless charging method may include, for example, a magnetic resonance method, a magnetic induction method, an electromagnetic method, and the like. Additional circuits (e.g., a coil loop, a resonance circuit, a rectifier, etc.) for wireless charging may be further included. The battery gauge may measure, for example, the residual charge quantity of a battery, and a voltage, a current, or a temperature while charging. The battery may include, for example, a rechargeable battery and/or a solar battery.

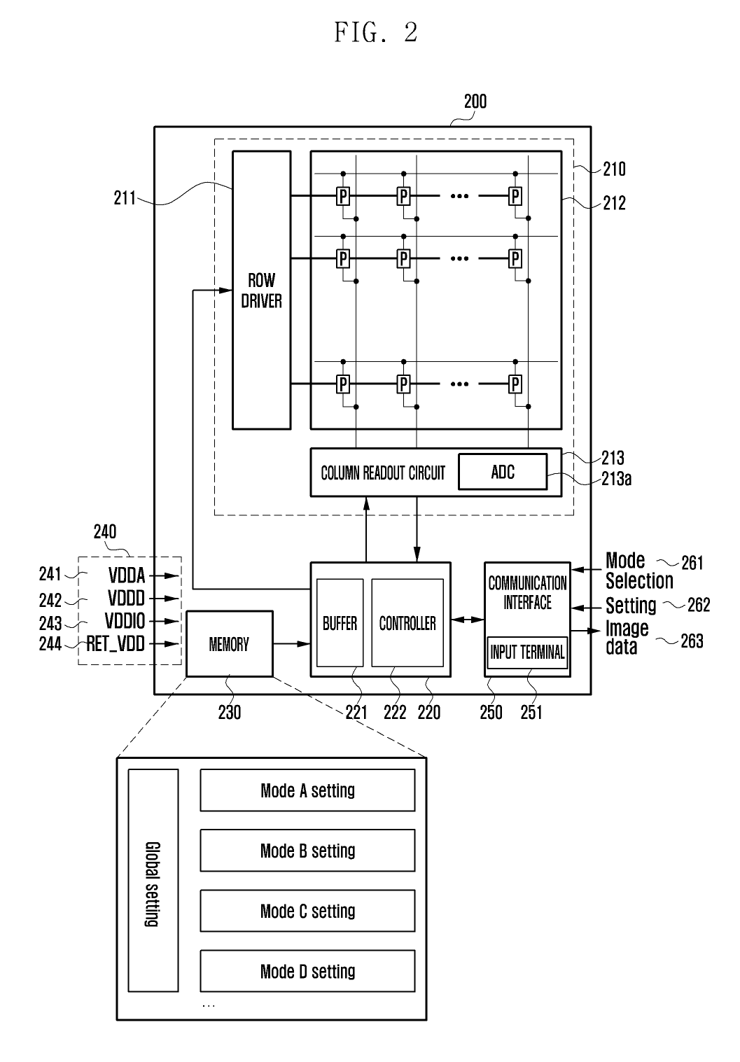

FIG. 2 is a block diagram of an image sensor 200 according to various embodiments of the present disclosure. The image sensor 200 may be a component of a camera contained in the electronic device 101. For example, the image sensor 200 may generate image data by receiving power supplied from power management module 170. The image sensor 200 may transmit the generated image data to other components (e.g., the processor 120, the memory 130, the communication interface 160, and the power management module 170) through the input/output interface 140 and the bus 110.

Referring to FIG. 2, the image sensor 200 includes an analog block 210, a digital control block 220, a memory 230, a power source interface 240, and a communication interface 250.

The analog block 210 may convert light, which is collected through a lens, into an electric signal, and may output the electric signal to the digital control block 220. For example, the analog block 210 may include a row driver 211, a pixel array 212, and a column readout circuit 213.

The row driver 211 may output a control signal (e.g., a selection signal, a reset signal, and a transmission signal) to the pixel array 212.

The pixel array 212 may include a plurality of pixels (P(i,j); herein, i and j indicate the location of a pixel, and i denotes a row number and j denotes a column number), which are arranged in 2 dimensions. For example, each of at least some pixels may include a photoelectric transformation element (or a photo sensing element, position sensitive detector (PSD), and a plurality of transistors (e.g., a reset transistor, a transmission transistor, a selection transistor, and a drive transistor). Also, the pixel array 212 may include a plurality of column lines. Each of the column lines (Lⱼ) may be electrically connected to pixels, which are arranged in the column direction. The pixels in the i^{th} row in the pixel array 212 receive a control signal from the row driver 211, and performs photoelectric transformation (transforming an optical signal into an electric signal), so as to output an electric signal to the column readout circuit 213.

For example, the reset transistor may reset a floating diffusion (FD) area of a corresponding pixel in response to a reset signal (RS). The transmission transistor transmits an electric charge accumulated in a photoelectric transformation element to a floating diffusion area in response to a transmission signal. The drive transistor may amplify the electric potential of electric charge accumulated in a floating diffusion area. The selection transistor may output the electric potential that is amplified by the drive transistor to a column line in response to a selection signal.

The column readout circuit 213 sequentially selects column lines one by one, receives an electric signal from a selected column line, and outputs the electric signal to the digital control block 220. Also, the column readout circuit 213 includes an analog-digital converter (ADC) 213a that converts an electric signal received from the selected column line into pixel data, and outputs the pixel data. According to an embodiment of the present disclosure, the analog-digital converter 213a may be included in the digital control block 220 or may be included in a separate component.

The digital control block 220 may temporarily store, in a buffer 221, pixel data received from the column readout circuit 213, and may output image data to another component (e.g., the processor 120) of the electronic device 101 through the communication interface 250 when the pixel data of the designated pixels are collected (that is, when single image data is obtained).

Also, the digital control block 220 may further include a controller 222 that is configured to control the analog block 210, the analog-digital converter 213a (ADC), and the buffer 221. The controller 222 may control the operations of the row driver 211 (e.g., a reset operation (e.g., an operation of outputting a reset signal to the pixels in an i^{th} column out of the pixels), a transmission operation (e.g., an operation of outputting a transmission signal to the pixels of the i^{th} column) and a row line selecting operation (e.g., an operation of outputting a select signal to the pixels in the i^{th} column)). Also, the controller 222 may control a column line selecting operation of the column readout circuit 213 (e.g., an operation of enabling a j^{th} column line and disabling the remaining column lines). Also, the controller 222 may control an operation of inputting and outputting data in the buffer 221. A series of operations (e.g., a reset operation, a transmission operation, a row line selecting operation, a data collecting operation, a data outputting operation, and the like), which are performed to generate image data and to output the same to a processor (e.g., the processor 120), may be referred to as a streaming operation (in other words, a streaming mode).

According to various embodiments of the present disclosure, the streaming operation may be performed based on setting information stored in the memory 230. For example, the controller 222 may control a streaming operation based on setting information stored in the memory 230 in response to a streaming command received from another component (e.g., the processor 120) of the electronic device 101 through the communication interface 250. When streaming is not required, the image sensor 200 may be operated in a standby mode. The standby mode may also be referred to as a retention mode. For example, in the case in which the memory 230 is a volatile memory, during a retention mode, power is supplied to the memory 230 so as not to delete the setting information, and supplying power to other components (e.g., the analog block 210 and the digital control block 220) may be suspended.

According to an embodiment of the present disclosure, the setting information stored in the memory 230 may include information associated with a parameter for driving a camera (e.g., a white balance, a shutter speed, a light sensitivity setting, and the like). Also, for example, the setting information stored in the memory 230 may include information associated with a designated photographing mode (e.g., a video mode, a still image photographing mode, a panorama mode, a scene mode, and the like). For example, in the retention mode, the image sensor 200 may maintain a parameter for driving a camera or information associated with a photographing mode, and may execute previewing or photographing based on the information when the image sensor 200 is changed from the retention mode to a preview mode.

The memory 230 may receive setting information for a streaming operation from another component (e.g., the processor 120) of the electronic device 101 through the communication interface 250, and may store the same. The image sensor 200 may execute various streaming operations. The memory 230 may receive, through the communication interface 250, setting information (e.g., a mode A setting, a mode B setting, a mode C setting, and a mode D setting) for each streaming mode from another component (e.g., the processor 120) of the electronic device 101.

For example, the mode A setting may include information used when the image sensor 200 executes a full streaming mode (e.g., a mode of generating image data by driving all of the pixels of the pixel array 212). The mode B setting, the mode C setting, and the mode D setting may include information used when the image sensor 200 executes a binning mode (e.g., a mode of generating image data by driving some of the pixels of the pixel array 212). For example, 2×2 binning (e.g., corresponding to a mode A) may indicate an operation of driving one pixel out of 4 pixels. A global setting stored in the memory 230 may include setting information that is commonly required to execute a streaming mode. Also, a setting may include a setting for recording a video. Also, a setting may include a setting for photographing a still image. Also, a setting may include a setting for providing slow motion by executing high-speed photographing when compared to general photographing.

The power source interface 240 may be connected to the power management module 170 of the electronic device 101 through one power line, or through a plurality of power lines, and may supply power for driving the image sensor 200. For example, the power source interface 240 may include a power source terminal (voltage of drain analog (VDDA)) 241 that receives power from the power management module 170 through a first power source line, and supplies the power to the analog block 210, a power source terminal (voltage of drain digital (VDDD)) 242 that receives power from the power management module 170 through a second power source line, and supplies the power to the digital control block 220, a power source terminal (voltage of drain input output (VDDIO)) 243 that receives power from the power management module 170 through a third power source line, and supplies power to the input/output interface (e.g., an interface for the communication between the memory 230 and the processor 120), and a power source terminal (retention voltage of drain (RET_VDD)) 244 that receives power from the power management module 170 through a fourth power source line, and supplies power to the memory 230. According to an embodiment of the present disclosure, the power source terminals 241 to 243 may be used as a terminal for supplying power to the memory 230.

The RET_VDD 244 may be a power source for maintaining setting information stored in the memory 230. For example, the RET_VDDA 244 may maintain the setting information stored in the memory 230 even while an execution command for a camera function does not exist.

The communication interface 250 may connect the digital control block 220 and the memory 230 to a component (e.g., the processor 120) of the electronic device 101 through at least one data line, and may transfer a command of the processor 120 to the digital control block 220. Also, for example, the communication interface 250 may be an interface that transfers setting information stored in the memory 130 to the memory 230 under the control of the processor 120 or the controller 222. For example, the communication interface 250 may include an input terminal 251 that receives, from the processor 120, a command for setting an operation mode of the image sensor 200 to a streaming mode or a retention mode, and transfers the command to the digital control block 220. Also, the communication interface 250 may receive, from the processor 120, a command 261 for selecting one of the streaming modes, and transfers the command 261 to the digital control block 220.

According to an embodiment of the present disclosure, the communication interface 250 receives the mode setting information 262 from the processor 120, and transfers the same to the memory 230. The image sensor 200 may communicate with the processor 120 through the communication interface 250 based on, for example, a serial communication scheme. For example, the memory 230 (as a slave) of the image sensor 200 may execute data communication with the processor 120 (as a master) through the communication interface 250 in an inter-integrated circuit (I²C) communication scheme. The I²C communication scheme may support, for example, 400 kbit/s, which is a fast mode, and 3.4 Mbit/s, which is a high-speed mode. When the I²C communication supports 400 kbit/s between the image sensor 200 and the processor 120, and information required to set streaming with an AE (auto exposure) is 1000 lines (4 bits per line), the time expended for loading the information to the memory 230 may be approximately 300 ms.

According to an embodiment of the present disclosure, the processor 120 acts as a master and the controller 222 acts as a slave, and thus, mode setting information may be stored in the memory 230.

According to an embodiment of the present disclosure, the communication interface 250 may output, to the processor 120, the image data 263 generated from the digital control block 220. The image sensor 200 may communicate with the processor 120 through the communication interface 250 based on a serial communication scheme. For example, the serial communication between the digital control block 220 and the processor 120 may support a mobile industry processor interface (MIPI) communication scheme. The digital control block 220 may output the image data 263 to the processor 120 through the communication interface 250 by using the communication scheme.

Although the image sensor 200, according to various embodiments of the present disclosure, has been described as an image sensor and a component of a camera for ease of description, it is not limited thereto and includes various modifications. For example, the image sensor 200 may be a component included in a display (e.g., the display 150) or a biometric sensor that is functionally connected to the electronic device 101.

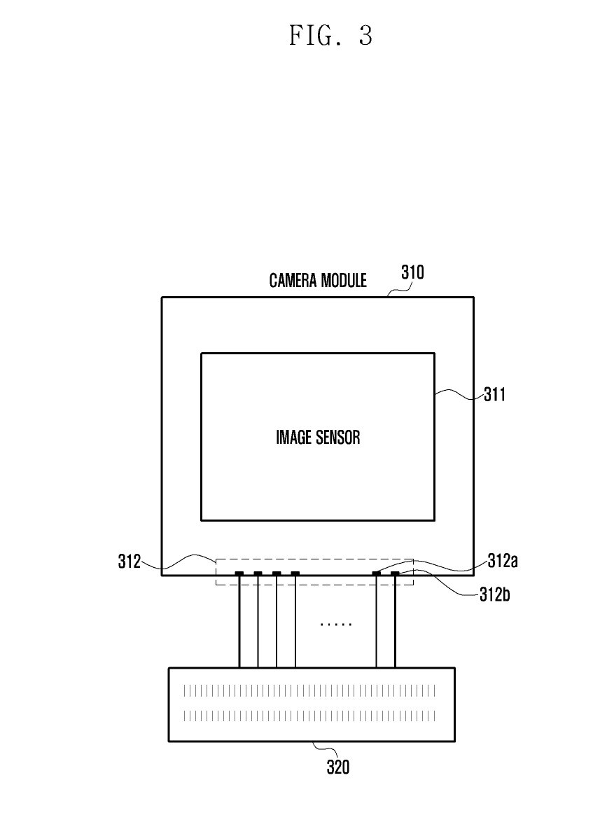

FIG. 3 illustrates a camera module 310 according to various embodiments of the present disclosure.

The camera module 310 may be a component of the electronic device 101. For example, the camera module 310 may be connected to other components (e.g., the processor 120, the memory 130, the communication interface 160, and the power management module 170) of the electronic device 101, through the input/output interface 140 and the bus 110.

Referring to FIG. 3, the camera module 310 includes a lens, an image sensor 311, and a terminal set 312. Here, the image sensor 311 may include a part or the entire image sensor 200 of FIG. 2. The terminal set 312 may include power source terminals, data input terminals, and data output terminals. According to an embodiment of the present disclosure, the terminal set 312 may further include a power source terminal 312a to supply power to a memory of the image sensor 311 (e.g., the memory 230) and an input data terminal 312b to transfer, to a digital control block of the image sensor 311 (e.g., the digital control block 220), a command for setting an operation mode of the image sensor 311 to a streaming mode or a retention mode.

Each terminal of the terminal set 312 may be connected to each terminal of the connector 320. The connector 320 may be connected to components of the electronic device 101. Therefore, the camera module 310 may be supplied with power from the power management module 170 through the connector 320. Also, the camera module 310 may communicate (e.g., data communication) with the processor 120, the memory 130, and the like, through the connector 320.

According to an embodiment of the present disclosure, the camera module 310 may further include a processor. For example, the processor (e.g., an image signal processor (ISP)) included in the camera module 310 may process image data received from the image sensor 311 (e.g., compress image data to store the same in the memory 230, resize image data to preview the same through the display 150, and the like), and may transfer the processed data to the processor 120 through the connector 320. Also, the processor included in the camera module 310 may perform similar functions as the processor 120. For example, the processor included in the camera module 310 may control supplying power to the image sensor 311. Also, the processor included in the camera module 310 may operate the operation mode of the image sensor 311 as a streaming mode or a retention mode. The processor included in the camera module 310 may correspond to the controller 223 of FIG. 2.

According to an embodiment of the present disclosure, the electronic device 101 may include an image sensor (e.g., the image sensor 200). For example, the electronic device 101 may include one or more camera modules in the front and the rear of the electronic device 101, respectively. At least one of the two or more camera modules may include an image sensor (e.g., the image sensor 200). Another image sensor may be driven as a retention mode based on setting information stored in a memory (e.g., the memory 230) included in an image sensor.

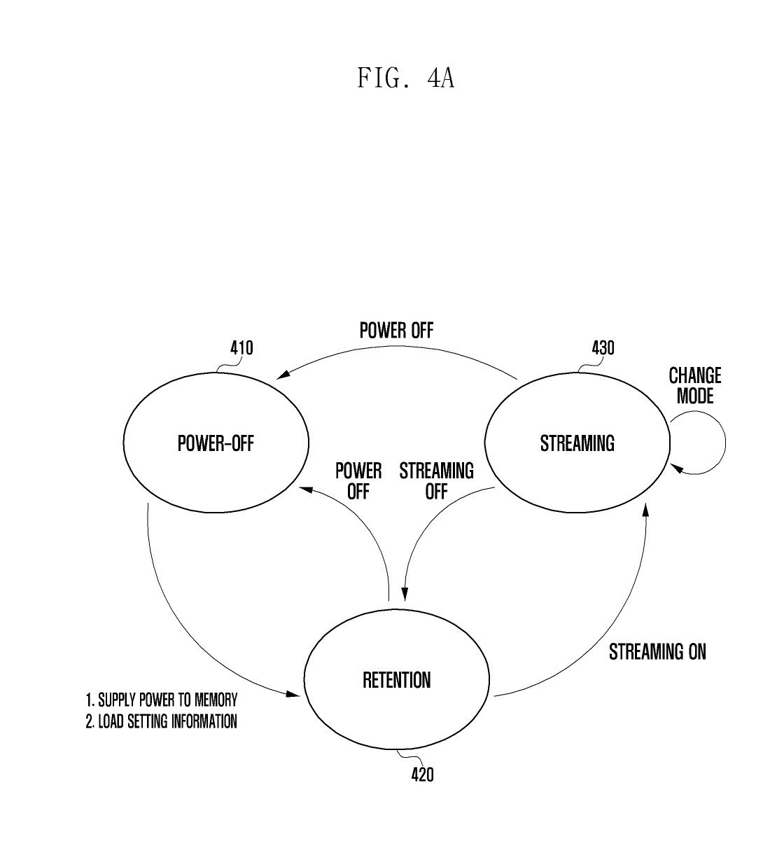

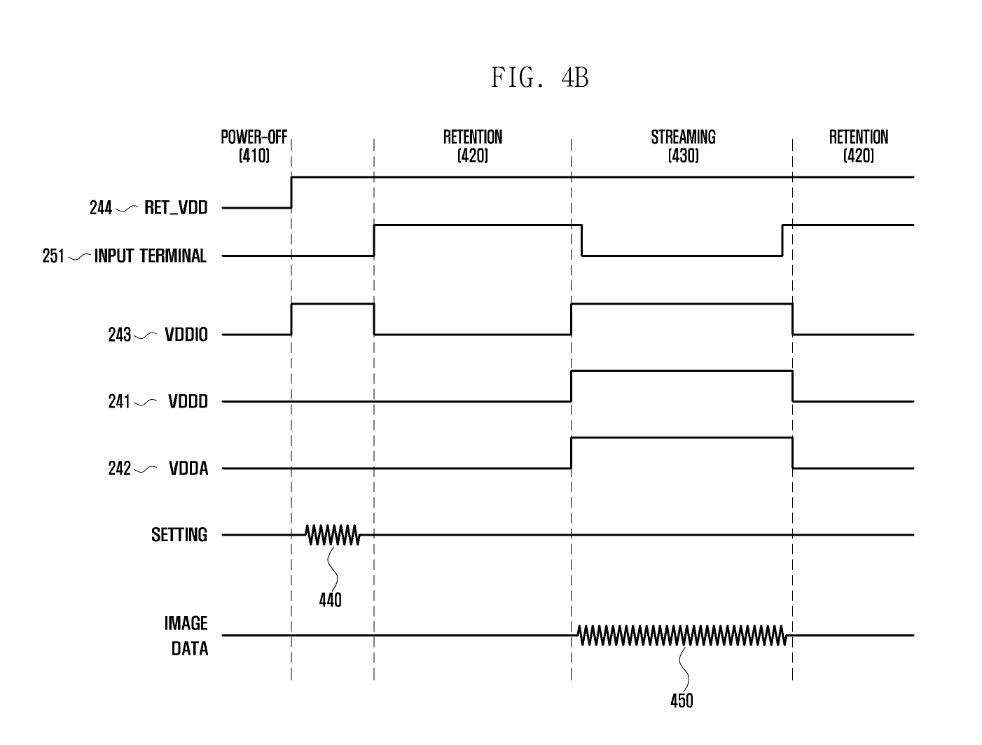

FIGS. 4A and 4B illustrate a change in the state of the image sensor 200 according to various embodiments of the present disclosure.

Referring to FIGS. 4A and 4B, the image sensor 200 may be in a power-off state 410 in which supplying power is suspended. The state of the image sensor 200 may be changed from the power-off state 410 to a retention state 420. For example, power may be supplied to the memory 230 (e.g., a part that stores at least a setting) from the power management module 170 through the RET_VDD terminal 244. Also, for the communication between the memory 230 and the processor 120, power may be supplied to an input/output interface of the image sensor 200 from the power management module 170 through the VDDIO terminal 243.

For example, when power is supplied to the memory 230, setting information 440 may be loaded, through the communication interface 250, to the memory 230 from the processor 120. When setting information is loaded, the image sensor 200 may be in the retention state 420 in which setting information is included. For example, the processor 120 may command the image sensor 200 to operate in the retention mode by changing a voltage level of the input terminal 251 of the communication interface 250 (e.g., changing a voltage level from ‘low’ to ‘high’ or vice versa). For example, during the retention state 420, supplying power to the memory 230 (e.g., a part that stores at least a setting) through the RET_VDD terminal 244 may be maintained, and supplying power to an input/output interface through the VDDIO terminal 243 may be suspended. While setting information 440 is loaded, the VDDIO terminal 243 may be turned on or off, as illustrated in FIG. 4B.

The state of the image sensor 200 may be changed from the retention state 420 to a streaming state 430. For example, the processor 120 may control the power management module 170 to begin supplying power to the analog block 210, the digital control block 220, and the input/output interface, through the power source terminals 241 to 243. When supplying power begins, the processor 120 may command the image sensor 200 to operate in the streaming mode by changing a voltage level of the input terminal 251 of the communication interface 250 (e.g., changing a voltage level from high to low or vice versa).

The image sensor 200, for example, may perform a streaming operation in response to the command without communication with an external component (e.g., without receiving setting information from the processor 120, the memory 130, or the communication interface 160). For example, in response to the command, the controller 222 may read setting information by accessing the memory 230. The controller 222 may control the streaming operation of the analog block 210, the ADC 213a, and the buffer 221, based on the read setting information. The image data 450 generated by the analog block 210, the ADC 213a, and the buffer 221 may be transferred to the processor 120 through the communication interface 250. As illustrated in FIG. 4B, during the streaming state 430, supplying power to the memory 230 (e.g., a part that stores at least setting) through the RET_VDD terminal 244 may be continuously maintained.

The state of the image sensor 200 may be changed from the streaming state 430 to the retention state 420. For example, the processor 120 may command the image sensor 200 to operate in the retention mode by changing a voltage level of an RET ON terminal of the communication interface 250 (e.g., changing a voltage level from low to high or vice versa). In response thereto, the image sensor 200 may suspend the streaming operation. Also, the processor 120 may control the power management module 170 to suspend supplying power to the analog block 210, the digital control block 220, and the input/output interface through the power source terminals 241 to 243. In response thereto, the power management module 170 may suspend supplying power to at least one of the analog block 210, the digital control block 220, and the input/output interface. Accordingly, the image sensor 200 may enter the retention state 420 in which supplying power to only the memory 230 is maintained.

The state of the image sensor 200 may be changed from the retention state 420 to the power-off state 410. For example, the processor 120 may command the power management module 170 to suspend supplying power to the memory 230 through the RET_VDD terminal 244. In response thereto, the power management module 170 may suspend supplying power to the memory 230, and the image sensor 200 may enter the power-off state 410 in which supplying power is suspended.

The state of the image sensor 200 may be changed from the streaming state 430 to the power-off state 410. For example, the processor 120 may transmit, to the image sensor 200, a command for suspending streaming (e.g., changing a voltage level of the input terminal 251). When streaming is suspended, the processor 120 may transmit, to the power management module 170, a command for suspending supplying power to the image sensor 200. In response thereto, the power management module 170 may suspend supplying power to all of the components of the image sensor 200, and the image sensor 200 enters the power-off state 410 in which supplying power is suspended.

According to an embodiment of the present disclosure, for example, the image sensor 200 may supply power to a memory through the RET_VDD 244 in the retention mode, and may supply power to the memory through another terminal (VDDIO 243, VDDD 241, or VDDDA 242) in the streaming mode.

According to an embodiment of the present disclosure, the image sensor 200 may change the setting of the streaming mode during the streaming state 430. For example, the processor 120 may transmit, to the image sensor 200, a command for changing the streaming mode. The controller 222 of the image sensor 200 may receive the command through the communication interface 250. In response to the command, the controller 222 may read setting information corresponding to the command by accessing the memory 230. The controller 222 may control the streaming operation of the analog block 210, the ADC 213a, and the buffer 221 based on the read setting information.

According to an embodiment of the present disclosure, the image sensor 200 may change, in the retention state 420, the setting information loaded in the memory 230. For example, the controller 222 may update the setting information loaded in the memory by using the setting information received through the communication interface 250. For example, the processor 120 may change at least a part of the stored setting information in the retention mode in response to the state of the electronic device 101 (e.g., a residual amount of battery power, a type of executed application, a property of data received from a base station) or a user command.

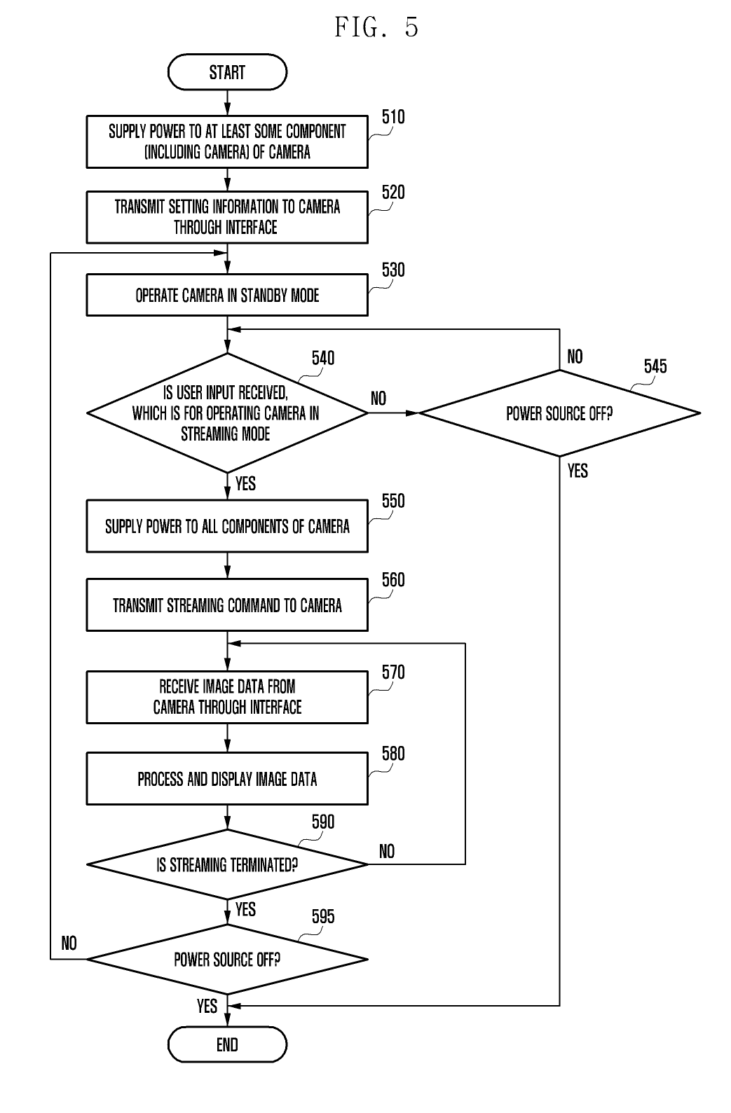

FIG. 5 is a flowchart illustrating a method of operating a camera according to various embodiments of the present disclosure. In an electronic device (e.g., the electronic device 101) formed of a camera (e.g., the camera module 310) and a processor (e.g., the processor 120), the processor may control a camera operating method. Here, the camera may have the image sensor 200, and may communicate with the processor by being connected to the processor through an interface (e.g., the input/output interface 140). Also, the camera, for example, may be supplied with power from a battery or an external power supply device through the power management module 170.

Referring to FIG. 5, in step 510, the processor 120 provides power to at least some components (e.g., including the memory 230 of the image sensor 200) of the camera.

According to an embodiment of the present disclosure, when a user presses a power button in the state in which the power source of the electronic device 101 is turned off, battery power may be supplied to the processor 120 through the power management module 170. When power is supplied, the processor 120 may load various programs into a main memory from a non-volatile memory for the operation of the electronic device 101. The processor 120 may access the program loaded into the main memory, may decode an instruction of the program, and may execute a function as a result of decoding. For example, the processor may transmit, to the power management module 170, a command for supplying power to the memory 230, as a result of decoding an instruction. In response to the command, the power management module 170 may supply power to the memory 230 of the image sensor 200.

According to an embodiment of the present disclosure, when a user presses a power button in the state in which the power source of the electronic device 101 is turned off, the power management module 170 may supply battery power to the memory 230 of the image sensor 200 in response to the pressing of the power button.

According to an embodiment of the present disclosure, the power management module 170 may supply power to the display 150 under the control of the processor 120. When power is supplied, the display 150 may display a previously stored image (e.g., a lock screen, a home screen, or an image that is displayed immediately before the screen is turned off). Also, when the screen is turned on, the power of the battery may be supplied to the memory 230 of the image sensor 200 by the power management module 170.

In step 520, the processor 120 reads setting information stored in the memory 130, and transmits the setting information to the memory 230 of the image sensor 200 of the camera through an interface (e.g., the input/output interface 140). In this case, the setting information may be recorded in the memory 230 using the power supplied to the memory 230.

In step 530, the processor 120 operates the camera in a standby mode. For example, when the camera is set to the standby mode, the processor 120 may command the power management module 170 to maintain supplying power to only the memory 230 from among the components of the camera. In response to the command, the power management module 170 maintains supplying power to the memory 230, and may suspend supplying power to other components. The standby mode may also be referred to as a retention mode.

In step 540, the processor 120 determines whether a user input for operating the camera in the streaming mode is received from an input device (e.g., a touch screen, a microphone, a key pad, and the like). When the user input is not received, the processor 120 determines whether to suspend supplying power to the memory 230 in step 545. For example, when the screen of the display 150 is turned off or a user input that requests turning off the power source of the electronic device 101 is received, the processor 120 may command the power management module 170 to suspend supplying power to the memory 230. When it is required to maintain supplying power to the memory 230 (e.g., when the screen of the display 150 is continuously turned on), the processor 120 may maintain the operating mode of the camera as a standby mode.

In response to the reception of the user input for operating the camera in the streaming mode (e.g., when a user touches an icon displayed on the screen that corresponds to a camera application), the processor 120 commands the power management module 170 to supply power to other components (e.g., the analog block 210 and the digital control block 220) of the camera, excluding the memory 230, in step 550.

Also, in response to the user input for operating the camera in the streaming mode, the processor 120 transmits a streaming command to the camera in step 560. In response to the streaming command, the camera generates image data (or generates and processes (e.g., resizes) the image data), and transfers the same to the processor 120. For example, the camera may generate image data based on setting information that is received in the standby mode and stored in the memory 230, and may transfer the same to the processor 120.

In step 570, the processor 120 receives image data from the camera through an interface (e.g., the communication interface 160).

In step 580, the processor 120 processes the received image data as a preview image (e.g., renders the image data to be shown on the screen, and controls the display 150 to display the preview image. For example, the camera may display the preview image using setting information that is received in the standby mode and stored in the memory 230. According to an embodiment of the present disclosure, the processor 120 or the controller 223 may store, in the memory 130, a still image or video data when an image capture command is received. The still image or video data stored in response to the capture command may be generated using the setting information stored in the memory 230 in the standby mode.

In step 590, the processor 120 determines whether to terminate streaming. For example, when the execution of the camera application is continued, the processor 120 may maintain the operation mode of the camera as a streaming mode. Accordingly, the processor 120 may repeatedly perform steps 570 and 580.

When the execution of the camera application is terminated or when the screen is turned off since supplying power to the display 150 is suspended, the processor 120 may determine to terminate streaming.

When the termination of streaming is determined, additionally; the processor 120 determines whether to suspend supplying power to the camera in step 595. For example, when the screen is turned off since supplying power to the display 150 is suspended, the processor 120 may command the power management module 170 to suspend supplying power to the camera. Alternatively, when the power source of the electronic device 101 is turned off, supplying power to other designated components in addition to the camera may be suspended. From the perspective of the camera, when supplying power to the memory 230 is required, the processor 120 may perform step 530. That is, the operation mode of the camera may be changed from the streaming mode to the standby mode.

According to an embodiment of the present disclosure, when the electronic device 101 is changed from a lock state to an unlock state, the processor 120 may execute at least one of the operations for operating the image sensor 200 in the retention state (e.g., the retention state 420). For example, when the electronic device 101 is changed from a lock state to an unlock state, the processor 120 may supply power to the memory 230 of the image sensor 200, and may transmit setting information to the memory 230. For example, when the electronic device 101 is changed from an unlock state to a lock state, the processor 120 may change the image sensor 200 from a retention state (e.g., the retention state 420) to a power-off state (e.g., a power-off state 410).

According to an embodiment of the present disclosure, the processor 120 may operate the image sensor 200 in the retention mode, based on the location information of the electronic device 101. The location information of the electronic device 101 may be determined using GNSS, Wi-Fi, Bluetooth, and the like. The electronic device 101 may operate the image sensor 200 in the retention mode in a location designated by a user.

According to an embodiment of the present disclosure, the processor 120 may operate the image sensor 200 in the retention mode when the electronic device 101 is connected to another electronic device that is designated.

According to an embodiment of the present disclosure, the processor 120 may operate the image sensor 200 in the retention mode during a designated time (e.g., 09:00˜11:00, 2 hours after setting, and the like).

According to an embodiment of the present disclosure, the processor 120 may operate the image sensor 200 in the retention mode, based on a type of application executed in the electronic device 101. For example, when an application related to a picture or a video is executed, the processor 120 may operate the image sensor 200 in the retention mode. The application used for operating the image sensor in the retention mode may be designated or cancelled by a user.

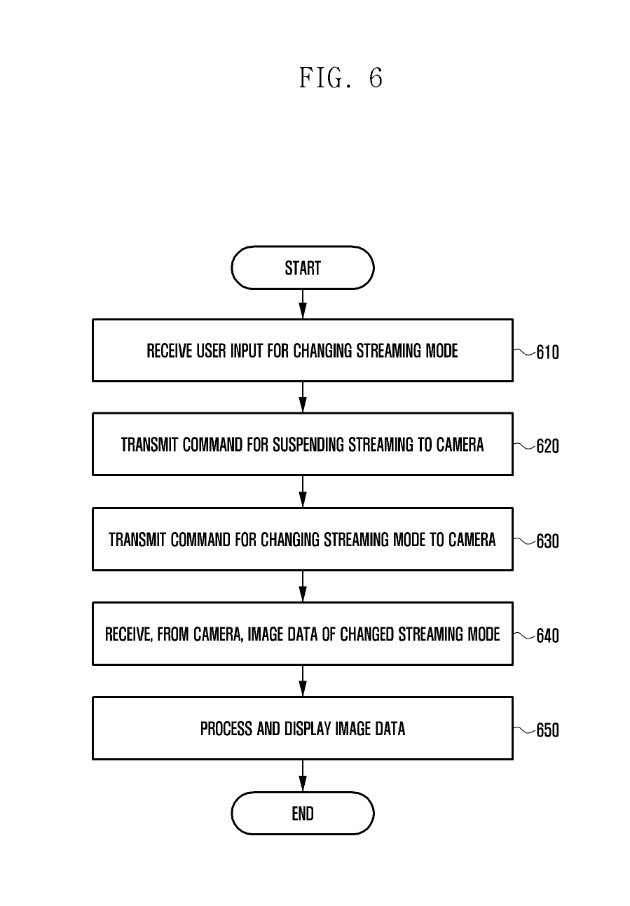

FIG. 6 is a flowchart illustrating a method of changing streaming according to various embodiments of the present disclosure. The processor 120 may be the subject of a streaming changing method, and the processor 120 may communicate with a camera through an interface (e.g., the input/output interface 140). Here, the camera, for example, may be supplied with power from, for example, a battery through the power management module 170.

Referring to FIG. 6, the processor 120 may change the setting of the image sensor 200 using information stored in the memory 230. For example, the processor 120 may change a still image photographing mode into a video recording mode using the information stored in advance in the memory 230.

Referring to FIG. 6, the processor 120 receives a user input for changing a streaming mode from an input device (e.g., a touch screen, a microphone, a key pad, and the like) in step 610. According to an embodiment of the present disclosure, the processor 120 may receive a user input in the state in which the image sensor 200 of the camera executes streaming (e.g., generating and outputting image data corresponding to a mode A).

In response to the user input, the processor 120, for example, commands the image sensor 200 to suspend streaming in step 620. In response to the command, the image sensor 200 may suspend streaming.

In step 630, the processor 120 commands the image sensor 200 to change a streaming mode (a change from a mode A to a mode B). For example, the processor 120 may transmit, to the image sensor 200, information associated with a streaming mode selected by a user (e.g., the information indicates a mode B, and may be included in the user input and may be received by the processor 120). In response to the reception of the information, the controller 222 of the image sensor 200 may read setting information corresponding to the received information, and may control the analog block 210, the ADC 213a, and the buffer 221 to resume streaming corresponding to the read setting information.

In step 640 the processor 120 receives image data of the changed streaming mode (e.g., a mode B) from the camera.

In step 650 the processor 120 processes the received image data as a preview image to be shown on the screen, and controls the display 150 to display the preview image.

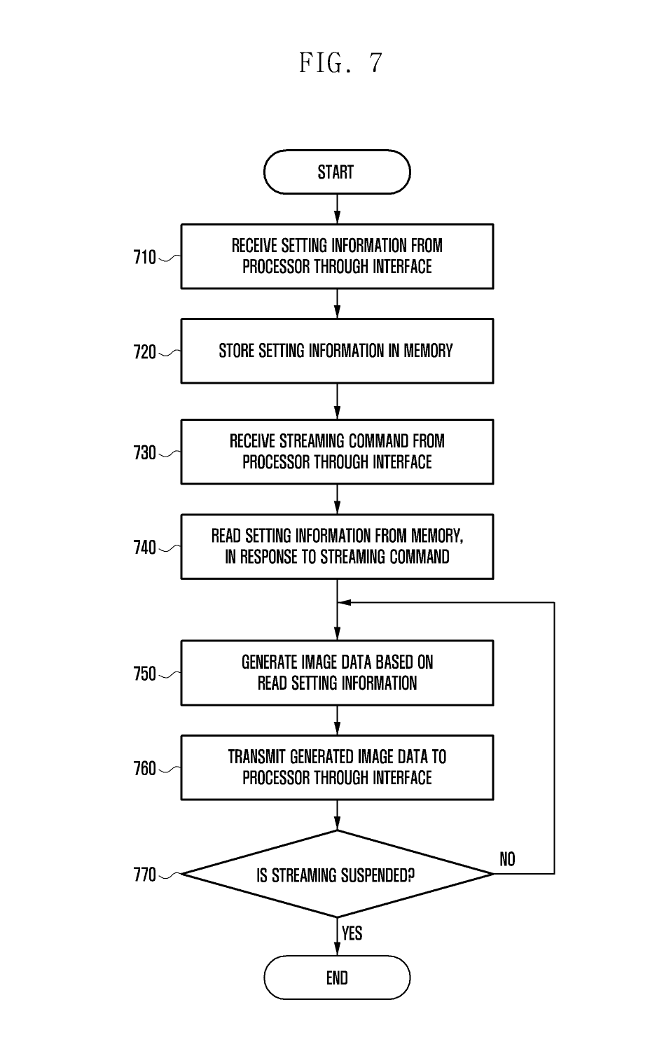

FIG. 7 is a flowchart illustrating an operation method of an image sensor (e.g., the image sensor 200) according to various embodiments of the present disclosure.

Referring to FIG. 7, in step 710, the image sensor receives setting information from the processor 120 through an interface (e.g., the input/output interface 140).

In step 720, the image sensor stores the received setting information in an embedded memory (e.g., the memory 230) of an image sensor.

In step 730, the image sensor receives a streaming command from the processor 120 through an interface.

In response to the streaming command, the image sensor reads the setting information from its embedded memory in step 740.

In step 750, the image sensor generates image data based on the read setting information.

In step 760, the image sensor transmits the image data to the processor through an interface.

In step 770, the image sensor determines whether to suspend streaming. For example, when a command for suspending steaming is received from the processor, the image sensor may suspend streaming in response to the command. Otherwise, the image sensor may return to step 750 and continuously executes steaming.

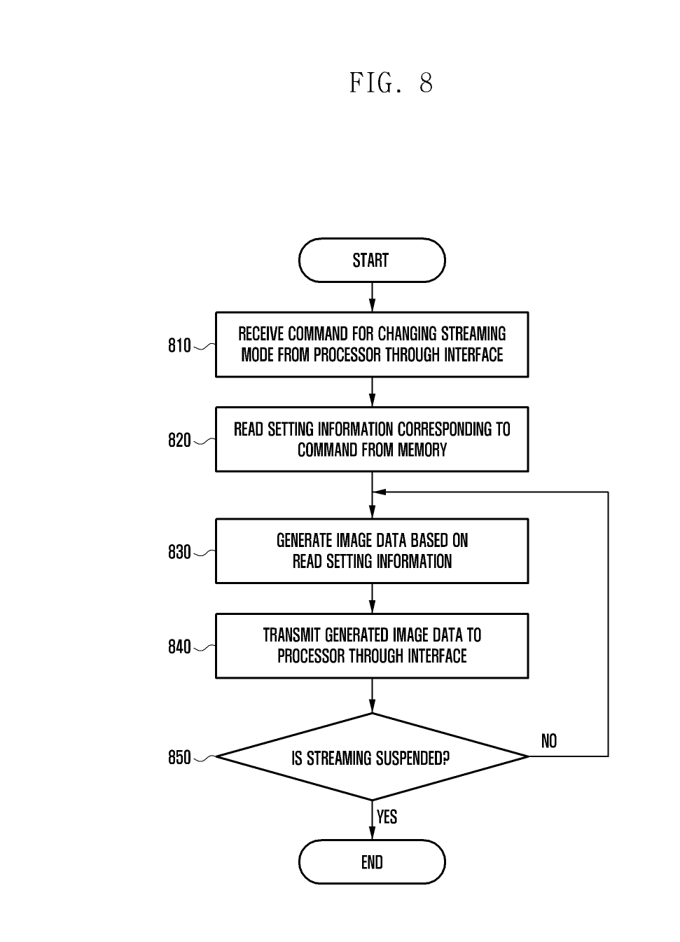

FIG. 8 is a flowchart illustrating another operation method of an image according to various embodiments of the present disclosure.

Referring to FIG. 8, during the execution of streaming (e.g., generating and outputting image data corresponding to a mode A) or the suspension of streaming, the image sensor receives a “command for changing a streaming mode (e.g., changing a mode A to a mode B) from the processor 120 through the interface (e.g., the input/output interface 140), in step 810.

In response to the command, the image sensor reads setting information corresponding to the command from an embedded memory (e.g., the memory 230) in step 820.

In step 830, the image sensor generates image data based on the read setting information.

In step 840, the image sensor transmits the image data to the processor through an interface.

In step 850, the image sensor determines whether to suspend streaming. For example, when a command for suspending steaming is received from the processor, the image sensor may suspend streaming in response to the command. Otherwise, the image sensor may return to step 830 and continuously executes steaming.

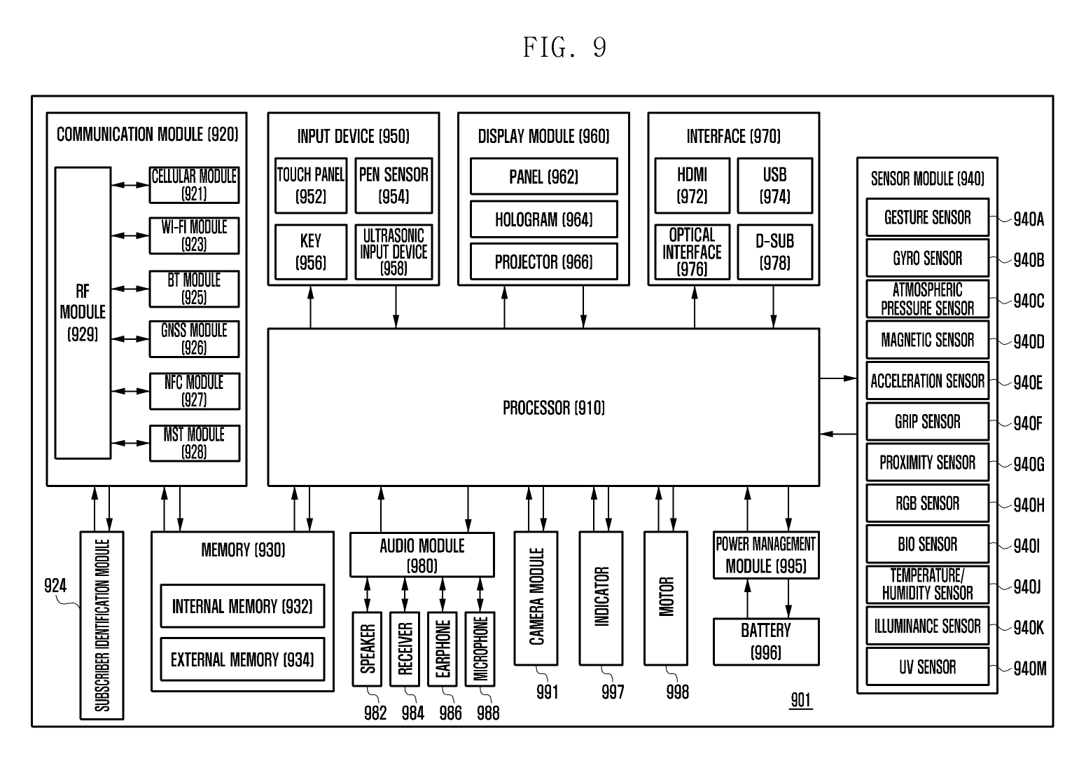

FIG. 9 is a block diagram of an electronic device according to various embodiments. For example, the electronic device 901 includes part or all of the components in the electronic device 101 shown in FIG. 1. The electronic device 901 includes one or more processors 910 (e.g., application processors (APs)), a communication module 920, a subscriber identification module (SIM) 924, a memory 930, a sensor module 940, an input device 950, a display 960, an interface 970, an audio module 980, a camera module 991, a power management module 995, a battery 996, an indicator 997, and a motor 998.

The processor 910 is capable of driving, for example, an operating system or an application program to control a plurality of hardware or software components connected to the processor 910, processing various data, and performing operations. The processor 910 may be implemented as, for example, a system on chip (SoC). According to an embodiment, the processor 910 may further include a graphic processing unit (GPU) and/or an image signal processor. The processor 910 may also include at least part of the components shown in FIG. 9, e.g., a cellular module 921. The processor 910 is capable of loading commands or data received from other components (e.g., a non-volatile memory) or a volatile memory, processing the loaded commands or data. The processor 910 is capable of storing various data in a non-volatile memory.

The communication module 920 includes a cellular module 921, a WiFi module 923, a Bluetooth (BT) module 925, a GNSS module 926 (e.g., a GPS module, Glonass module, Beidou module or Galileo module), an NFC module 927, a MST module 928, and a radio frequency (RF) module 929.

The cellular module 921 is capable of providing a voice call, a video call, an SMS service, an Internet service, etc., through a communication network, for example. According to an embodiment, the cellular module 921 is capable of identifying and authenticating an electronic device 901 in a communication network by using a subscriber identification module (SIM) 924 (e.g., a SIM card). The cellular module 921 is capable of performing at least part of the functions provided by the processor 910. The cellular module 921 is also capable of including a communication processor (CP).

Each of the WiFi module 923, the BT module 925, the GNSS module 926, and the NFC module 927 may include a processor for processing data transmitted or received through the corresponding module. The MST module 928 may include a processor for processing data transmitted or received through the corresponding module. According to embodiments, at least part of the cellular module 921, WiFi module 923, BT module 925, GNSS module 926, NFC module 927, and MST module 928 (e.g., two or more modules) may be included in one integrated chip (IC) or one IC package.

The RF module 929 is capable of transmission/reception of communication signals, e.g., RF signals. The RF module 929 may include a transceiver, a power amp module (PAM), a frequency filter, a low noise amplifier (LNA), an antenna, etc. According to another embodiment, at least one of the following modules, including the cellular module 921, WiFi module 923, BT module 925, GNSS module 926, NFC module 927, and MST module 928 is capable of transmission/reception of RF signals through a separate RF module.

The SIM module 924 may include a card including an embodied SIM. The SIM module 924 is also capable of containing unique identification information, e.g., integrated circuit card identifier (ICCID), or subscriber information, e.g., international mobile subscriber identity (IMSI).

The memory 930 includes a built-in memory 932 or an external memory 934. The built-in memory 932 may include at least one of the following: a volatile memory, e.g., a dynamic RAM (DRAM), a static RAM (SRAM), a synchronous dynamic RAM (SDRAM), etc., and a non-volatile memory, e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash memory, an NOR flash memory, etc.), a hard drive, a solid state drive (SSD), etc.

The external memory 934 may include a flash drive, e.g., a compact flash (CF), a secure digital (SD), a micro secure digital (micro-SD), a mini secure digital (mini-SD), an extreme digital (xD), a multi-media card (MMC), a memory stick, etc. The external memory 934 is capable of being connected to the electronic device 901, functionally and/or physically, through various interfaces.

The memory 930 is capable of storing payment information and a payment application serving as one of the application programs. The payment information may refer to credit card numbers and PINs, corresponding to a credit card. The payment information may also include user authentication information, e.g., fingerprints, facial features, voice information, etc.

When the payment application is executed by the processor 910, it may enable the processor 910 to perform an interaction with the user to make payment (e.g., displaying a screen to select a card (or a card image) and obtaining information (e.g., a card number) corresponding to a selected card (e.g., a pre-specified card) from payment information) and an operation to control magnetic field communication (e.g., transmitting the card information to an external device (e.g., a card reading apparatus) through the NFC module 927 or MST module 928).

The sensor module 940 is capable of measuring/detecting a physical quantity or an operation state of the electronic device 901, and converting the measured or detected information into an electronic signal. The sensor module 940 includes a gesture sensor 940A, a gyro sensor 940B, an atmospheric pressure sensor 940C, a magnetic sensor 940D, an acceleration sensor 940E, a grip sensor 940F, a proximity sensor 940G, a color sensor 940H (e.g., a red, green and blue (RGB) sensor), a biometric sensor 940I, a temperature/humidity sensor 940J, an illuminance sensor 940K, and a ultraviolet (UV) sensor 940M. Additionally or alternatively, the sensor module 940 is capable of further including an E-nose sensor, an electromyography (EMG) sensor, an electroencephalogram (EEG) sensor, an electrocardiogram (ECG) sensor, an infrared (IR) sensor, an iris sensor and/or a fingerprint sensor. The sensor module 940 may include a control circuit for controlling one or more sensors included therein. The electronic device 901 may include a processor, configured as part of the processor 910 or a separate component, for controlling the sensor module 940. In this case, while the processor 910 is operating in sleep mode, the processor is capable of controlling the sensor module 940.

The input device 950 includes a touch panel 952, a (digital) pen sensor 954, a key 956, or an ultrasonic input unit 958. The touch panel 952 may be implemented by a capacitive touch system, a resistive touch system, an infrared touch system, and an ultrasonic touch system. The touch panel 952 may further include a control circuit. The touch panel 952 may also further include a tactile layer to provide a tactile response to the user.

The (digital) pen sensor 954 may be implemented with a part of the touch panel or with a separate recognition sheet. The key 956 may include a physical button, an optical key, or a keypad. The ultrasonic input unit 958 is capable of detecting ultrasonic waves, created in an input tool, through a microphone 988, and identifying data corresponding to the detected ultrasonic waves.

The display 960 includes a panel 962, a hologram unit 964, or a projector 966. The panel 962 may be implemented to be flexible, transparent, or wearable. The panel 962 may also be incorporated into one module together with the touch panel 952. The hologram unit 964 is capable of showing a stereoscopic image in the air by using light interference. The projector 966 is capable of displaying an image by projecting light onto a screen. The screen may be located inside or outside of the electronic device 901. According to an embodiment, the display 960 may further include a control circuit for controlling the panel 962, the hologram unit 964, or the projector 966.

The interface 970 includes a high-definition multimedia interface (HDMI) 972, a universal serial bus (USB) 974, an optical interface 976, or a D-subminiature (D-sub) 978. Additionally or alternatively, the interface 970 may include a mobile high-definition link (MHL) interface, a secure digital (SD) card/multimedia card (MMC) interface, or an infrared data association (IrDA) standard interface.

The audio module 980 is capable of providing bidirectional conversion between a sound and an electronic signal. The audio module 980 is capable of processing sound information input or output through a speaker 982, a receiver 984, earphones 986, microphone 988, etc.

The camera module 991 refers to a device capable of taking both still and moving images. According to an embodiment, the camera module 991 may include one or more image sensors (e.g., a front image sensor or a rear image sensor), a lens, an image signal processor (ISP), a flash (e.g., an LED or xenon lamp), etc.

The power management module 995 is capable of managing power of the electronic device 901. According to an embodiment, the power management module 995 may include a power management integrated circuit (PMIC), a charger IC, or a battery gauge. The PMIC may employ wired charging and/or wireless charging methods. Examples of the wireless charging method are magnetic resonance charging, magnetic induction charging, and electromagnetic charging. To this end, the PMIC may further include an additional circuit for wireless charging, such as a coil loop, a resonance circuit, a rectifier, etc. The battery gauge is capable of measuring the residual charge capacity, charge in voltage, current, or temperature of the battery 996. The battery 996 may take the form of either a rechargeable battery or a solar battery.

The indicator 997 is capable of displaying a specific status of the electronic device 901 or a part thereof (e.g., the processor 910), e.g., a boot-up status, a message status, a charging status, etc. The motor 998 is capable of converting an electrical signal into mechanical vibrations, such as, a vibration effect, a haptic effect, etc. The electronic device 901 may include a processing unit (e.g., GPU) for supporting a mobile TV. The processing unit for supporting a mobile TV is capable of processing media data pursuant to standards, e.g., digital multimedia broadcasting (DMB), digital video broadcasting (DVB), or mediaFlo™, etc.

Each of the elements described in the present disclosure may be formed with one or more components, and the names of the corresponding elements may vary according to the type of the electronic device. In various embodiments, the electronic device may include at least one of the above described elements described in the present disclosure, and may exclude some of the elements or further include other additional elements. Further, some of the elements of the electronic device may be coupled to form a single entity while performing the same functions as those of the corresponding elements before the coupling.

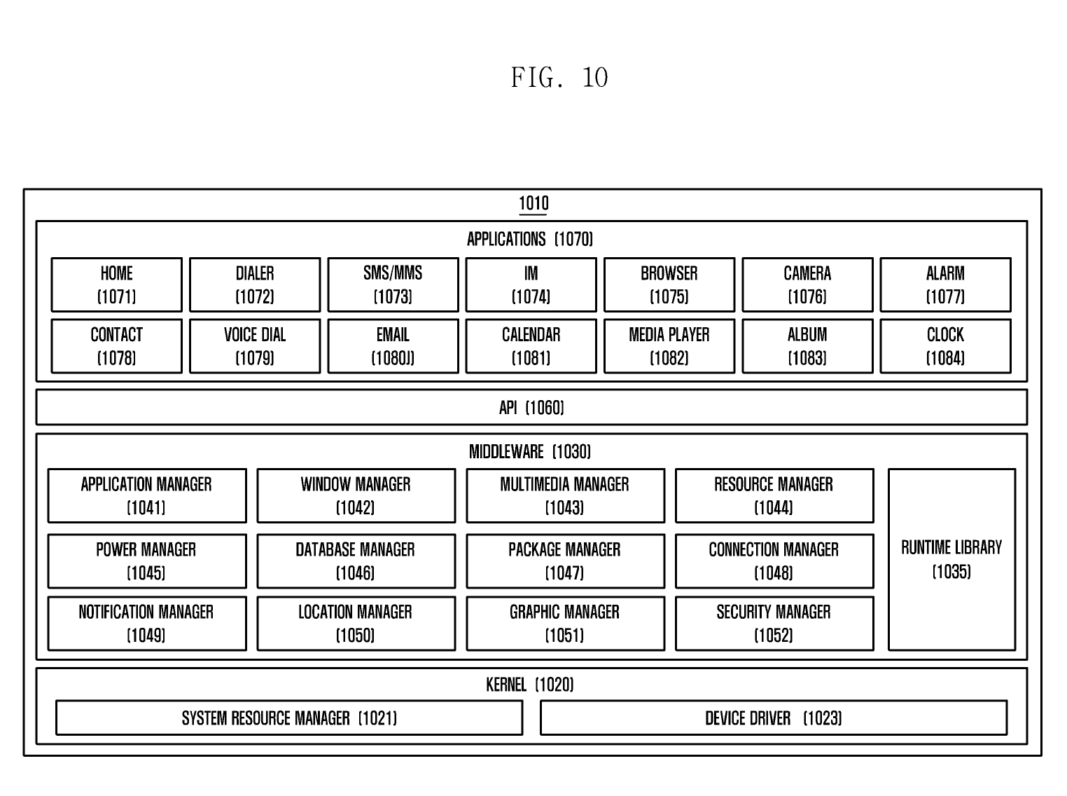

FIG. 10 is a block diagram of a programming module according to various embodiments. The program module 1010 may include an operation system (OS) for controlling resources related to the electronic device (e.g., electronic device 11) and/or various applications (e.g., application programs 14D shown in FIG. 1) running on the OS. The OS may be Android, iOS, Windows, Symbian, Tizen, Bada, etc.

The program module 1010 includes a kernel 1020, middleware 1030, application programming interface (API) 1060 and applications 1070. At least part of the program module 1010 may be preloaded on the electronic device or downloaded from a server.

The kernel 1020 includes a system resource manager 1021 and/or a device driver 1023. The system resource manager 1021 may include, for example, a process manager, a memory manager, and a file system manager. The system resource manager 1021 may perform a system resource control, allocation, and recall. The device driver 1023 may include, for example, a display driver, a camera driver, a Bluetooth driver, a shared memory driver, a USB driver, a keypad driver, a WiFi driver, and an audio driver. Further, according to an embodiment, the device driver 312 may include an inter-process communication (IPC) driver.

The middleware 1030 may provide a function required in common by the applications 1070. Further, the middleware 1030 may provide a function through the API 1060 to allow the applications 1070 to efficiently use limited system resources within the electronic device. According to an embodiment, the middleware 1030 includes at least one of a runtime library 1035, an application manager 1041, a window manager 1042, a multimedia manager 1043, a resource manager 1044, a power manager 1045, a database manager 1046, a package manager 1047, a connection manager 1048, a notification manager 1049, a location manager 1050, a graphic manager 1051, and a security manager 1052.

The runtime library 1035 may include, for example, a library module used by a complier to add a new function through a programming language while the applications 1070 are executed. According to an embodiment, the runtime library 1035 executes input and output, management of a memory, a function associated with an arithmetic function and the like.

The application manager 1041 may manage, for example, a life cycle of at least one of the applications 1070. The window manager 1042 may manage GUI resources used on the screen. The multimedia manager 1043 may detect a format required for reproducing various media files and perform an encoding or a decoding of a media file by using a codec suitable for the corresponding format. The resource manager 1044 manages resources such as a source code, a memory, or a storage space of at least one of the applications 1070.

The power manager 1045 may operate together with a Basic Input/Output System (BIOS) to manage a battery or power and provides power information required for the operation. The database manager 1046 may manage generation, search, and change of a database to be used by at least one of the applications 1070. The package manager 1047 may manage an installation or an update of an application distributed in a form of a package file.

The connection manager 1048 may manage, for example, a wireless connection such as WiFi or Bluetooth. The notification manager 1049 may display or notify a user of an event such as an arrival message, an appointment, a proximity alarm and the like, in a manner that does not disturb the user. The location manager 1050 may manage location information of the electronic device. The graphic manager 1051 may manage a graphic effect provided to the user or a user interface related to the graphic effect. The security manager 1052 provides a general security function required for a system security or a user authentication. According to an embodiment, when the electronic device has a call function, the middleware 1030 may further include a telephony manager for managing a voice of the electronic device or a video call function.

The middleware 1030 may include modules configuring various combinations of functions of the above described components. The middleware 1030 is capable of providing modules specialized according to types of operation systems to provide distinct functions. The middleware 1030 may be adaptively configured in such a way as to remove part of the existing components or to include new components.

The API 1060 may be a set of API programming functions, and may be provided with a different configuration according to an operating system. For example, in Android or iOS, a single API set may be provided for each platform. In Tizen, two or more API sets may be provided.

The applications 1070 includes one or more applications for performing various functions, e.g., home 1071, diary 1072, SMS/MMS 1073, instant message (IM) 1074, browser 1075, camera 1076, alarm 1077, context 1078, voice dial 1079, email 1080, calendar 1081, media player 1082, album 1083, clock 1084, health care (e.g., an application for measuring amount of exercise, blood sugar level, etc.), and environment information (e.g., an application for providing atmospheric pressure, humidity, temperature, etc.).

According to an embodiment, the applications 1070 may include an application for supporting information exchange between an electronic device (e.g., electronic device 101) and an external device (e.g., electronic devices 102 and 104). The information exchange application is a notification relay application for relaying specific information to external devices or a device management application for managing external devices.

For example, the notification relay application relays notification information, created in other applications of the electronic device (e.g., SMS/MMS application, email application, health care application, environment information application, etc.) to external devices (e.g., electronic devices 102 and 104). In addition, the notification relay application is capable of receiving notification information from external devices to provide the received information to the user.

The device management application is capable of managing (e.g., installing, removing or updating) at least one function of an external device (e.g., electronic devices 102 and 104) communicating with the electronic device. Examples are turning-on/off the external device or part of the external device, controlling the brightness (or resolution) of the display, applications running on the external device, services provided by the external device, etc. Examples of the services are a call service, messaging service, etc.

According to an embodiment, the applications 1070 are capable of including an application (e.g., a health care application of a mobile medical device, etc.) specified attributes of an external device. The applications 1070 are capable of including applications received from an external device. The applications 1070 are capable of including a preloaded application or third party applications that may be downloaded from a server. It should be understood that the components of the program module 1010 may be called different names according to types of operating systems.

According to various embodiments, at least part of the program module 1010 may be implemented with software, firmware, hardware, or any combination of two or more of them. At least part of the program module 1010 may be implemented (e.g., executed) by a processor (e.g., processor 120). At least part of the programming module 1010 may include modules, programs, routines, sets of instructions or processes, etc., in order to perform one or more functions.

The term ‘module’ as used in various embodiments of the present disclosure may mean a unit including one of hardware, software, and firmware or any combination of two or more of them. The term ‘module’ may be interchangeable with the term ‘unit,’ ‘logic,’ ‘logical block,’ ‘component,’ or ‘circuit.’ The ‘module’ may be the smallest unit of an integrated component or a part thereof. The ‘module’ may be the smallest unit that performs one or more functions or a part thereof. The ‘module’ may be mechanically or electronically implemented. For example, the ‘module’ according to various embodiments of the present disclosure may include at least one of application-specific integrated circuit (ASIC) chips, field-programmable gate arrays (FPGAs), and programmable-logic devices for performing certain operations, which are now known or will be developed in the future.

At least part of the method (e.g., operations) or system (e.g., modules or functions) according to various embodiments may be implemented with instructions as programming modules that are stored in computer-readable storage media. One or more processors (e.g., processor 120) may execute instructions, thereby performing the functions. An example of the computer-readable storage media may be a memory 130. At least part of the programming modules may be implemented (executed) by a processor. At least part of the programming module may include modules, programs, routines, sets of instructions or processes, etc., in order to perform one or more functions.

Examples of computer-readable media include magnetic media, such as hard disks, floppy disks, and magnetic tape, optical media such as compact disc read only memory (CD-ROM) disks and digital versatile disc (DVD); magneto-optical media, such as floptical disks; and hardware devices that are specially configured to store and perform program instructions (e.g., programming modules), such as read-only memory (ROM), random access memory (RAM), flash memory, etc. Examples of program instructions include machine code instructions created by assembly languages, such as a compiler, and code instructions created by a high-level programming language executable in computers using an interpreter, etc. The described hardware devices may be configured to act as one or more software modules in order to perform the operations and methods described above, or vice versa.

Modules or programming modules according to various embodiments may include one or more components, remove part of them described above, or include new components. The operations performed by modules, programming modules, or the other components, according to various embodiments, may be executed in serial, parallel, repetitive or heuristic fashion. Part of the operations may be executed in any other order, skipped, or executed with additional operations.

The embodiments described in the present disclosure are merely provided to assist in understanding the disclosure and the technology thereof and are not suggestive of limitation. Although embodiments of the disclosure have been described in detail above, it should be understood that many variations and modifications of the basic inventive concept herein described, which may be apparent to those skilled in the art, will still fall within the spirit and scope of the embodiments of the disclosure as defined in the appended claims and their equivalents.

What is claimed is:

1. An image sensor, comprising:
a pixel array;
a memory configured to store setting information received from an external device of the image sensor; and
a controller configured to generate an image using a signal sensed in the pixel array, based on the setting information stored in the memory.

2. The image sensor of claim 1, wherein, when the external device or a power source of a display that is connected with the external device is activated, the memory is further configured to receive the setting information from the external device.

3. The image sensor of claim 1, wherein, while the external device or a power source of a display that is connected with the external device is activated, the controller is further configured to maintain supplying power to the memory.

4. The image sensor of claim 3, wherein the controller is further configured to not supply power to other parts of the image sensor excluding the memory.

5. The image sensor of claim 4, wherein the controller is further configured to supply power to the other parts of the image sensor, based on a request for generating the image, which is received from the external device.

6. The image sensor of claim 1, wherein the setting information includes information associated with at least one of a white balance, a light sensitivity setting, a shutter speed, a still image photographing mode, a video recording mode, a panorama photographing mode, and a scene mode.

7. An electronic device, comprising:
a first memory;
an image sensor comprising a second memory;
a processor; and
a communication interface between the image sensor and the processor,
wherein the processor is configured to transmit setting information stored in the first memory to the second memory through the communication interface, and generate an image based on setting information stored in the second memory.

8. The electronic device of claim 7, further comprising:
a display connected with the processor,
wherein the processor is further configured to transmit the setting information to the image sensor while the display is active.

9. The electronic device of claim 8, wherein the processor is further configured to maintain supplying power to the second memory while the display is active.

10. The electronic device of claim 7, wherein, when a request for executing a camera application does not exist, the processor is further configured to not supply power to other parts of the image sensor excluding the second memory.

11. The electronic device of claim 7, wherein, when it is determined that the electronic device is changed from a lock mode to an unlock mode, the processor is further configured to transmit the setting information to the image sensor.

12. The electronic device of claim 7, wherein the setting information includes a plurality of pieces of setting information; and
the image sensor is configured to select, as a basis for generating image data, a setting corresponding to a command from among the plurality of pieces of setting information stored in the second memory in response to the command received from the processor.

13. The electronic device of claim 7, wherein the image sensor further comprises a power source terminal for providing power to the second memory, and is configured to maintain a power source to the second memory through the power supply terminal while a power source of the electronic device is turned on.

14. The electronic device of claim 13, further comprising:
a power management module configured to supply power to the processor, the image sensor, and the first memory,
wherein, when the power source of the electronic device is turned on or a screen of the electronic device is turned on, the first memory comprises instructions which when executed by the processor:
command the power management module to supply power to the second memory; and
transmit at least one setting to the second memory.

15. The electronic device of claim 14, wherein the first memory further comprises:
instructions, which when executed by the processor, enables, in response to a first user input, command the power managing module to supply power to an analog block and a digital control block of the image sensor which is configured to perform a streaming operation including generating and outputting the image data, and command the image sensor to begin the streaming operation; and
instructions, which when executed by the processor, enables, in response to a second user input, command the image sensor to suspend the streaming operation, and command the power management module to not supply power to the analog block and the digital control block.

16. The electronic device of claim 15, wherein the first memory further comprises instructions, which when executed by the processor, command the image sensor to change the streaming operation in response to a third user input; and
the image sensor is further configured to select a setting corresponding to the streaming change instruction from among the plurality of settings stored in the second memory in response to the streaming change command, and generate image data based on the selected setting.

17. The electronic device of claim 7, further comprising:
a power management module configured to maintain supplying power to the second memory while a power source of the electronic device is turned on or a screen of the electronic device is turned on.

18. The electronic device of claim 7, further comprising:
a power management module configured to supply power to the processor and the image sensor,
wherein the processor is further configured to control the power management module to maintain supplying power to the second memory while a power source of the electronic device is turned on or a screen of the electronic device is turned on.

19. A method of operating an electronic device including an image sensor and a power management module, the method comprising:
controlling the power management module to supply power to a memory of the image sensor when a power source of the electronic device is turned on or when a screen of the electronic device is turned on;
transmitting a setting to the memory;
commanding, in response to a first user input, the power management module to supply power to an analog block and a digital control block of the image sensor which is configured to execute a streaming operation including generating and outputting image data based on a setting stored in the memory, and the image sensor to begin the streaming operation; and
commanding, in response to a second user input, the image sensor to suspend the streaming operation, and the power management module to suspend supplying power to the analog block and the digital control block.

20. The method of claim 19, further comprising:
commanding the image sensor to change the streaming operation in response to a third user input.
